(19) United States
(12) Patent Application Publication
(10) Pub. No.: US 2024/0167968 A1
(43) Pub. Date: May 23, 2024

(54) RADIATION MEASUREMENT APPARATUS

(71) Applicant: Rigaku Corporation, Tokyo (JP)

(72) Inventors: Takuya KIKUCHI, Hachiouji-shi, Tokyo (JP); Tetsuya OZAWA, Ome-shi, Tokyo (JP); Ryuji MATSUO, Ome-shi, Tokyo (JP)

(73) Assignee: Rigaku Corporation, Tokyo (JP)

(21) Appl. No.: 18/283,011

(22) PCT Filed: Dec. 10, 2021
(86) PCT No.: PCT/JP2021/045512

§ 371 Date: Sep. 20, 2023

(30) Foreign Application Priority Data
Mar. 22, 2021 (JP) 2021-047755

(51) Int. Cl. G01N 23/20025

(52) U.S. Cl. CPC G01N 23/20025

(57) ABSTRACT

A pair of support sections arranged with a space for placing a sample, a frame supported by the pair of support sections, an irradiation section movably connected to the frame for irradiating radiation, and a detection section movably connected to the frame for detecting radiation scattered by the sample are comprised on a same plane, and the irradiation section and the detection section are movable on the same plane with respect to the frame. Thus, using a space formed between the pair of support sections, it is possible to measure a large sample in a wide range of diffraction angles. Therefore, it is easy to measure the diffraction of the low angle side. Further, since each part is movable on the same plane, it is easy to arrange the parts.

### CROSS-REFERENCE TO RELATED APPLICATIONS

This application is based on PCT filing PCT/JP2021/045512, filed Dec. 10, 2021, which claims priority from Japanese Patent Application No. 2021-47755, filed Mar. 22, 2021, the entire contents of each are incorporated in this international application.

### BACKGROUND

### Field

The present disclosure relates to a radiation measurement apparatus having a mechanism that enables measurement for various samples.

### DESCRIPTION OF THE RELATED ART

Conventionally, there is a desire to analyze the structure of large and complex parts in the shape as it is by X-rays. However, if structural analysis and stress analysis are attempted using X-rays for large samples, they cannot be installed in a stationary type of apparatus having a goniometer with a general rotation mechanism as they are. In such a case, a method of cutting a sample to measure is known (Non-Patent Document 1).

On the other hand, in the case of a portable device, X-rays can be irradiated, and the sample can be measured in situ without cutting. However, even if a portable device is used, the distance from the incident optical system to the measurement surface or the camera length is insufficient when the sample has a complex shape or a size more than a certain level, and the measurement becomes difficult.

Considering such circumstances, an apparatus for performing X-ray diffraction measurement for samples of various sizes and shapes has been proposed. For example, in the X-ray diffraction apparatus described in Patent Document 1, the fixture ring holds various components such as gears, and the X-ray head carrying the X-ray detector assembly is shiftably supported. Dedicated X-ray heads are available for various sizes and can be shifted in multiple different linear directions, such as in the z-axis and y-axis directions.

### Non-Patent Documents

Non-Patent Document 1: sin 2ψ method, JSMS-SD-10-05 Standard Method for X-Ray Stress Measurement, 2005, The Society of Materials Science, Japan

### PATENT DOCUMENTS

Patent Document 1: U.S. Pat. No. 4,532,501

However, even in the X-ray diffraction apparatus described in Patent Document 1, it is difficult to perform measurement unless the sample is corresponding to the size of the fixturing. Also, the X-ray head carries an X-ray detector assembly, and measurements are limited to a range of narrow diffraction angles.

### SUMMARY

The present disclosure has been made in view of the above circumstances, and an object thereof is to provide a radiation measurement apparatus capable of easily arranging each part and realizing efficient and highly versatile measurement.

(1) In order to achieve the above object, the radiation measurement apparatus of the present disclosure comprises a pair of support sections arranged with keeping a space for placing a sample, a frame supported by the pair of support sections, an irradiation section movably connected to the frame for irradiating radiation and a detection section movably connected to the frame for detecting radiation scattered by the sample, and in the radiation measurement apparatus, the irradiation section and the detection section are movable on the same plane with respect to the frame.

Thus, a large sample can be measured with a wide range of diffraction angles by using the space formed between the pair of support sections. Therefore, it is easy to measure the diffraction of the low angle side. Further, since the parts including the irradiation section and the detection section are movable on the same plane, it is easy to arrange the parts. Since the sample can be supported in the space formed in this manner to be measured by arranging the irradiating section and the detecting section in various positions, for example, even a sample having a small complex shape can be measured with the radiation. In this manner, efficient and highly versatile measurement can be carried out.

(2) Further, in the radiation measurement apparatus of the present disclosure, the detection section has two parallel movement axes parallel to the plane and perpendicular to each other and one rotational movement axis perpendicular to the plane. Since the arrangement can be adjusted by using the three movement axes in this manner, the diffraction beam can be appropriately detected. Further, the camera length can also be adjusted to prevent attenuation due to air, and that enables quick measurement.

(3) Further, in the radiation measurement apparatus of the present disclosure, the irradiation section has two parallel movement axes parallel to the plane and perpendicular to each other and one rotational movement axis perpendicular to the plane. Thus, the position of the irradiation section can be adjusted, and the position of the incident point on the sample can be flexibly controlled. This makes it possible to measure a sample having a complicated shape.

(4) Further, in the radiation measurement apparatus of the present disclosure, the frame is supported by the pair of support sections at two fulcrums and has a rotational movement axis connecting the fulcrums. Thus, the stress of the sample can be easily measured by the side inclination method using the rotational movement axis as the ψ axis.

(5) Further, in the radiation measurement apparatus of the present disclosure, the frame is formed as a single body. Thus, the movement mechanism of the irradiation section or the detection section is formed by a slide structure with respect to the frame, and it is possible to constrain their movement on a predetermined plane.

(6) Further, in the radiation measurement apparatus of the present disclosure, the frame is configured to be separated into the irradiation section side and the detection section side. As a result, since the center of the separated frame is empty, it is possible to measure a sample having a large outer shape by inserting the sample therebetween.

(7) Further, the radiation measurement apparatus of the present disclosure further comprises a sensor installed on the frame for detecting the position of the sample surface. Thus, the sample can be easily and accurately positioned.

(8) Further, in the radiation measurement apparatus of the present disclosure, the frame has a parallel movement mechanism capable of moving in a direction parallel to the plane with respect to the pair of support sections. Thus, the deflection of the frame can be adjusted.

(9) Further, in the radiation measurement apparatus of the present disclosure, the pair of support sections has a movement mechanism capable of approaching and separating from a sample placed in the space. This facilitates placement of the sample and coarse movement of the measurement system with respect to the sample, thereby enabling highly efficient measurement.

According to the present disclosure, it is possible to easily arrange the respective parts and to realize efficient and highly versatile measurement.

### BRIEF DESCRIPTION OF THE DRAWINGS

FIG. 1 is a perspective view showing a radiation measurement system of the present disclosure.

FIG. 2 is a perspective view showing an example of a sample.

FIGS. 3A and 3B are a front cross-sectional view and a plan view schematically showing a sample, respectively.

FIG. 4 is a schematic diagram showing an arrangement example of the incident optical system and the receiving optical system.

FIG. 5 is a graph showing a 20 measurement angle range with respect to the camera length.

FIG. 6 is a graph showing 20 with respect to the wavelength of the characteristic X-rays of respective reflecting surfaces.

FIGS. 7A, 7B, and 7C are perspective views showing a radiation measurement apparatus when the measured position is set to the left side, the center and the right from front view along the incident surface, respectively.

FIG. 8 is a perspective view showing a configuration of the iso-inclination method.

FIG. 9 is a perspective view showing a configuration of the side-inclination method.

FIGS. 10A, 10B, and 10C are perspective views showing radiation measurement apparatuses set the inclination of respective frames on the rear side, the center and the front side, respectively.

FIGS. 11A, 11B, and 11C are perspective views showing high angle measurements by a radiation measurement apparatus which sets the inclination of the center separated frame to the rear side, the center and the front side, respectively.

FIGS. 12A, 12B, and 12C are perspective views showing low angle measurements by a radiation measurement apparatus which sets the inclination of the center separated frame to the rear side, the center and the front side, respectively.

FIGS. 13A, 13B, and 13C are perspective views showing high angle measurements by a radiation measurement apparatus set the inclination of the center separated frame with counterweights the rear side, the center and the front side, respectively.

FIGS. 14A, 14B, and 14C are perspective views showing low angle measurements by a radiation measurement apparatus set the inclination of the center separated frame with counterweights on the rear side, the center and the front side, respectively.

### DETAILED DESCRIPTION

Next, embodiments of the present disclosure are described with reference to the drawings. To facilitate understanding of the description, the same reference numerals are assigned to the same components in the respective drawings, and duplicate descriptions are omitted.

### First Embodiment (X-ray Structure Analysis at Low Angle)

(System Configuration)

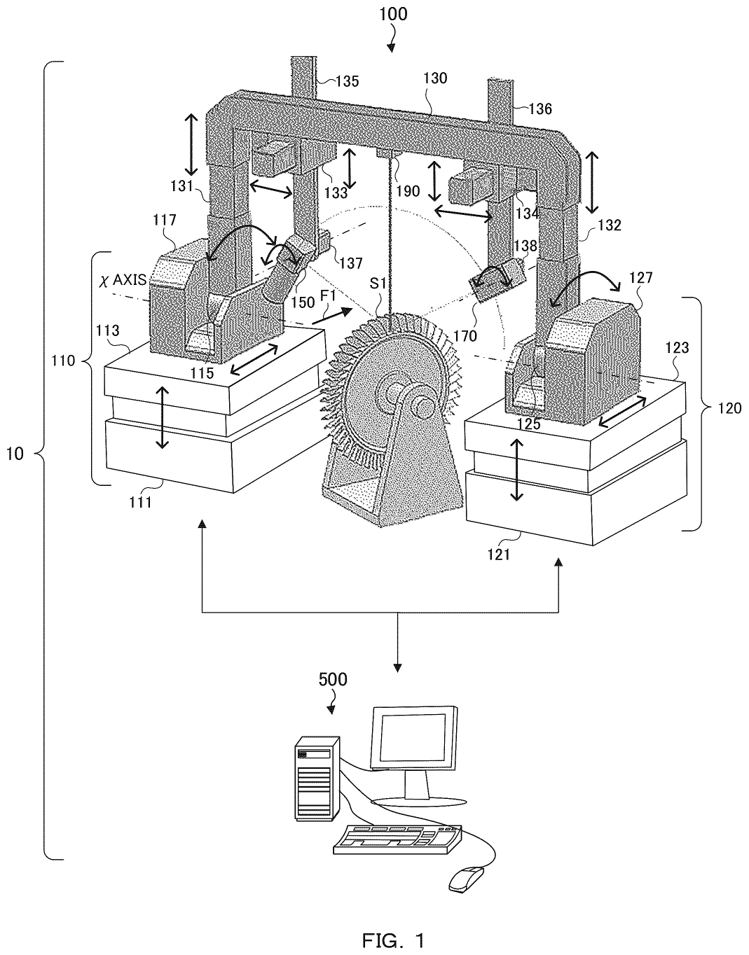

FIG. 1 is a perspective view of an X-ray measurement system 10. The X-ray measurement system 10 includes an X-ray measurement apparatus 100 (radiation measurement apparatus) and a control apparatus 500. Although described below as an example in the case of using X-rays, it is also possible to use radiation such as a-rays, neutron-rays, electron-rays or y-rays. The X-ray measurement apparatus 100 has a configuration capable of adjusting the camera length and diffraction angle for large or complex shaped samples. The control apparatus 500 is a computer, such as a PC, that includes a processor and memory and is capable of executing programs. The X-ray measurement apparatus 100 operates in accordance with control instructions of the control apparatus 500.

(Apparatus Configuration)

The X-ray measurement apparatus 100 includes a pair of support sections 110 and 120, a frame 130, an irradiation section 150, a detection section 170 and a sensor 190. In the example shown in FIG. 1, the turbine blade is placed as a sample S1 between the pair of support sections 110 and 120. The arrow F1 in FIG. 1 shows the direction on viewing from the front. The words of “vertical”, “right-and-left” and “front-and-rear” in the following description mean directions when viewed from the front.

A pair of support sections 110 and 120 are located with a space for placing the sample S1, and swingably supports the frame 130 about the fulcrum 115 and 125. Thus, a large sample can be placed using the space formed between the pair of support sections 110 and 120, and measurement can be performed in a wide range of diffraction angles. Therefore, it is easy to measure the diffraction of the low angle side. Examples of the sample are described later.

The pair of support sections 110 and 120 are adjusted so that the fulcrums 115 and 125 have the same height. In one aspect, the measured position of the sample S1 is operated so as to be arranged on an axis (χ axis) connecting the fulcrums 115 and 125 at the time of measurement. The pair of support sections 110 and 120 can be provided with vertical movement mechanisms 111 and 121 for moving vertically along the vertical axis, and the front-and-rear movement mechanisms 113 and 123 for moving to the front side and the rear side along the front-and-rear movement axis. The vertical axes are axes in vertical direction located in the vertical movement mechanisms 111 and 121, the front-and-rear movement axes are axes perpendicular to the χ axis and in horizontal direction located in the front-and-rear movement mechanisms 113 and 123.

The vertical movement mechanisms 111 and 121 are used to adjust the measured position height to the rotational center height of the χ axis. The front-and-rear movement mechanisms 113 and 123 are used to always make the X-ray irradiated position the same even when the X-ray irradiated position is shifted due to deflection or the like by tilting the χ axis. Both of the movement mechanisms can employ a movement mechanism by gears. In particular, the vertical movement mechanisms 111 and 121 can be controlled by coarse movement and fine movement.

As described above, the pair of support sections 110 and 120 can have the vertical movement mechanisms 111 and 121 as movement mechanisms that can approach and separate the sample S1 placed in the space. This facilitates the placement of the sample S1 and the coarse movement of the measurement system with respect to the sample S1, thereby enabling highly efficient measurement.

The frame 130 is supported by the pair of support sections 110 and 120. The frame 130 is supported at two points of the fulcrum 115 and 125 by the pair of support sections 110 and 120 and can comprise a χ-axis rotation mechanisms 117 and 127 which rotates about the axis connecting the fulcrum 115 and 125 (χ-axis). Thus, the irradiation section 150 and the detection section 170 can be rotated about the χ axis, and it is possible to easily measure the stress of the sample S1 by the side-inclination method using the χ axis as ψ axis. The fulcrums 115 and 125 are located in the χ-axis rotation mechanisms 117 and 127, respectively. Incidentally, χ-axis rotation mechanisms 117 and 127 can be used to tilt the optical system toward a direction perpendicular to the scanning surface of the incident angle of X-rays and the scanning surface of the detector angle. The χ-axis rotation mechanisms 117 and 127 can also be used to set the normal line of the sample surface to coincide with the normal line of the diffraction surface each other, or to set the angle between them to be an arbitrarily inclined angle. As the χ-axis rotation mechanisms 117 and 127, it is possible to employ movable mechanisms by gears.

In one aspect, the frame 130 is formed as a single body in a U-shape. Thus, the movement mechanism of the irradiation section 150 or the detection section 170 is formed by a slide structure with respect to the frame 130, and they can be configured to be moved only on a predetermined plane (plane parallel to the incident surface). Two tip sections of the U-shaped frame 130 are rotatably supported by the support sections 110 and 120 at fulcrum positions.

The frame 130 can comprise θ vertical movement mechanisms 131 and 132 as parallel movement mechanisms that enable movement in a direction along the θ vertical axis in parallel with a predetermined plane with respect to the pair of support sections 110. The θ vertical axis is positioned perpendicular to the χ axis and parallel to the direction connecting the χ axis and the X-ray source in the θ vertical movement mechanisms 131 and 132. The θ vertical movement mechanisms 131 and 132 are used for changing the movable range of the θs vertical movement mechanism 135 and the θd vertical movement mechanism 136. Further, the θ vertical movement mechanisms 131 and 132 are also used for the change of the working space according to the size of the sample S1, or to reduce the deflection generated due to long strokes of the θs vertical movement mechanism 135 and the θd vertical movement mechanism 136. Incidentally, movable mechanisms by gears can be adopted for the θ vertical movement mechanisms 131 and 132.

The irradiation section 150 is movably connected to the frame 130 and irradiates X-rays. The irradiation section 150 comprises at least an X-ray source and can comprise optical equipment such as slits and mirrors according to circumstances. The irradiation section 150 is movable on the same plane with respect to the frame 130. Incidentally, the same plane indicates an incident plane and refers to a substantially same plane including an error associated with the driving mechanism. In one aspect, the Irradiation section 150 can have two parallel movement axes parallel to a predetermined plane and perpendicular to each other and one rotation movement axis perpendicular to the predetermined plane. Thus, the position of the irradiation section 150 can be adjusted the position of the incident point on the sample S1 can flexibly be controlled, and the measurement is possible even for a sample having a complex shape.

For the two parallel movement axes perpendicular to each other and parallel to a predetermined plane, the θs right-and-left movement axis and θs vertical axis are exemplified. The θs right-and-left movement axis is an axis parallel to the χ axis located in the frame 130, and the θs vertical axis is an axis perpendicular to the χ axis located in the θs vertical movement mechanism 135. The θs right-and-left movement mechanism 133 enables the irradiation section 150 to move along the θs right-and-left movement axis and is used for adjusting and scanning the incident angle of X-rays and for adjusting the incident distance matched to the object size. Further, the θs right-and-left movement mechanism 133 may be used for a retracting movement so as not to interfere with the apparatus when setting the object to the measurement position. For the θs right-and-left movement mechanism 133, a movable mechanism by a gear can be adopted.

The θs vertical movement mechanism 135 is used for adjusting and scanning the incident angle of X-rays along θs vertical axis. The θs vertical movement mechanism 135 may be used for adjusting the incident distance to match the object size. Further, the θs vertical movement mechanism 135 may be used for a retracting movement so as not to interfere with the apparatus when setting the object to the measurement position. For the θs vertical movement mechanism 135, a movable mechanism by a gear can be adopted. The θs right-and-left movement mechanism 133 and the θs vertical movement mechanism 135 can be connected to the portion extending to right and left of the frame 130 (the bottom portion of the U-shape) as slidable structures. The θs rotation mechanism 137 can hold the irradiation section 150 rotatable at the tip of the θs vertical movement mechanism 135.

One rotational movement axis perpendicular to a predetermined plane is the θs rotation axis. The θs rotation mechanism 137 performs rotation drive of the irradiation section 150 about the θs rotation axis and is used for adjusting and scanning the incident angle of X-rays. Further, the θs rotation mechanism 137 may be used for offset of the incident angle. For the θs rotation mechanism 137, a movable mechanism by a gear can be adopted.

The detection section 170 is movably connected to the frame 130, and detects X-rays scattered by the sample S1. For example, a two-dimensional semiconductor X-ray detector is used for the detection section 170, but the other two-dimensional detector, a zero-dimensional detector or a one-dimensional detector can also be used. The detection section 170 is movable on the same plane with respect to the frame 130. Incidentally, the same plane is an incident surface and refers to a substantial same plane including an error associated with the driving mechanism. Thus, because the detection section 170 is configured to be movable on the same plane, the detection section 170 can be easily placed.

The detection section 170 can have two parallel movement axes in parallel to a predetermined plane and perpendicular to each other and one rotational movement axis perpendicular to the predetermined plane. Since the arrangement of the detection section 170 can be adjusted by these three movement axes, the diffraction beams can be appropriately detected with respect to the incident beam. The camera length can also be adjusted to prevent attenuation due to air, enabling quick measurement.

As the two parallel movement axes perpendicular to each other in parallel to a predetermined plane, the θd right-and-left movement axis and the θd vertical axis are exemplified. The θd right-and-left movement axis is an axis parallel to the χ axis located in the frame 130, and the θd vertical axis is located in the θd vertical movement mechanism 136 and is an axis perpendicular to the χ axis. The θd right-and-left movement mechanism 134 makes the detection section 170 movable along θd right-and-left movement axis and is used for adjusting of the angle and scanning of the detection section 170. The θd right-and-left movement mechanism 134 may be used for adjustment of the camera length to match the sample size. The θd right-and-left movement mechanism 134 may be used for retracting movement so as not to interfere with the apparatus when the sample is set at the measurement position. For the θd right-and-left movement axis, a movable mechanism by a gear can be adopted.

The θd vertical movement mechanism 136 makes the detection section 170 movable along the θd vertical axis and is used for adjustment of the angle and scanning of the detection section 170. The θd vertical movement mechanism 136 may be used to adjust the camera length in accordance with the sample size or may be used for retreating movement so as not to interfere with the apparatus when the sample is set at the measurement position. For the θd vertical movement mechanism 136, a movable mechanism by a gear can be adopted.

As one rotational movement axis perpendicular to a predetermined plane, the θd rotation axis is exemplified. The θd rotation mechanism 138 rotates the detection section 170 about θd rotation axis. The θd rotation mechanism 138 is used for adjusting the angle and scanning of the detection section 170 and the offset of detector angles. For the θd rotation mechanism 138, a movable mechanism by a gear can be adopted. The θd right-and-left movement mechanism 134 and θs vertical movement mechanism 136 can be connected in slidable structures to the portion extending to the right-and-left of the frame 130 (the bottom portion of the U-shape). Further, the θd rotation mechanism 138 can hold the detection section 170 rotatable at the tip of the θd vertical movement mechanism 136.

The sensor 190 is installed on the frame 130 and detects the position of the surface of the sample S1. Thus, the sample S1 can be easily and accurately positioned. An encoder or laser displacement meter may be used for the sensor 190. The sensor 190 is positioned between the irradiation section 150 and the detection section 170, and since the irradiation section 150 and the detection section 170 can move in the right-and-left direction, the sensor 190 can also move in the right-and-left direction as well. Thus, the vertical and right-and-left movement of the frame 130 with respect to the sample S1 does not rely on machine accuracy but can be controlled by feeding back the current position in the required disassembly with the length measurement by the sensor.

### Examples of Suitable Samples

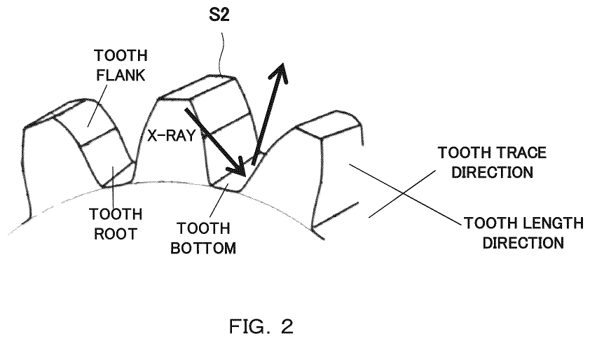

The X-ray measurement apparatus 100 configured as described above is particularly suitable for a large-sized, complex-shaped or a large-sized and complex-shaped sample. FIG. 2 is a perspective view showing an example of the sample S2. The sample S2 is a gear, and when attempting to measure the structure of the recess with X-rays, the convex portion is an obstacle, therefore X-rays can not be exposed to the structure, and it is difficult to measure the structure. Although the measurement of the tooth bottom is relatively easy, the measurement of the tooth face and the tooth flank is particularly difficult.

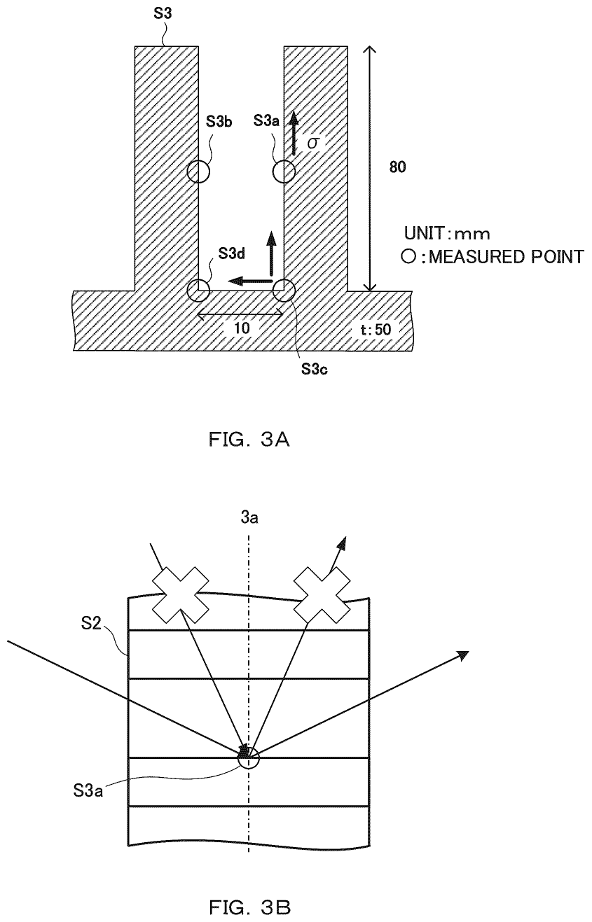

As for the turbine blades of aircraft jet engines which are large and have complicated shapes, it is difficult to measure the center and root parts of the blades as well as the gears. FIGS. 3A and 3B schematically illustrate examples of difficult-to-measure samples as described above. FIGS. 3A and 3B are a front cross-sectional view and a plan view schematically showing the sample S3, respectively. The dash-dot line 3a shown in FIG. 3B indicates a cross section of FIG. 3A.

As shown in FIG. 3A, the sample S3 has a shape in which concavities and convexities are repeated. When the structure of the measured points S3a to S3d of such a sample S3 is analyzed, it is effective to diffract X-rays at a low angle. In the example shown in FIG. 3B, by irradiating X-rays to the measured point S3a using a low-angle peak, and the diffracted X-rays are detected. In the X-ray measurement apparatus 100, the irradiation section 150 and the detection section 170 can be translated and rotated on a predetermined plane. Thus, the structural analysis using the peak of the low angle is possible.

When the measurement is performed at the measured points S3a and S3b, the measurement can be performed by irradiating X-rays to a position where the tip of the tooth of the sample S3 is vertical as shown in FIG. 1. When the measurement is performed at the measured points S3c and d, the measurement can be performed by irradiating X-rays to a position where the tip is horizontal.

In addition to such a turbine blade, for a narrow portion such as a crankshaft of an automobile component, a blisk and a recess of mold, there is a request to measure a part as it shaped, and X-ray measurement apparatus 100 can respond to the request. The same applies to large parts of composite materials, polymeric materials or thin film materials. In addition, the large parts that could not be accepted conventionally due to a capacity problem and the parts that X-rays could not be irradiated to or diffracted X-rays could not be detected due to the complex shape can also be the measurement object. For a material of the sample, a metal material, a ceramic material, a composite material, a polymer material, a thin film material, or the like can be used as a measurement target.

For the root of blisks and crankshafts, etc., the part cannot be located in the conventional apparatus. The parts that cannot be measured by conventional apparatus are often in places where load is applied in design. Non-destructive measurements of component shapes are expected to be applied to the quality improvement and the design evaluation of the components, and the importance of evaluating the strength of the components is further increasing because the weight reduction of vehicle bodies and aircraft is being promoted in order to reduce CO2 and improve fuel efficiency in the automotive and aeronautical industries.

Incidentally, there are various kinds of samples in which there is a demand for measurement, and if the stress analysis is for main metallic materials such as steel materials, Al, Ni, and Ti, the measurement can be performed at 2θ=50° to 120°. Further, the measurement can be performed in the range of 2θ=5° to 80° even for engineering plastics such as PP, PE, PEEK and GERP and thin film materials of TiN, Cr, and Cu.

Further, the X-ray measurement apparatus 100 can be used not only for stress analysis but also for qualitative and quantitative evaluation and texture evaluation. For example, in the case of a metal material, application to evaluation such as quantitation is conceivable. Especially, it is effective for the quantitation of retained austenite in steel materials. Further, the application to quantitative evaluation (crystallinity evaluation) of engineering plastics is also possible.

(Arrangement of Each Optical System)

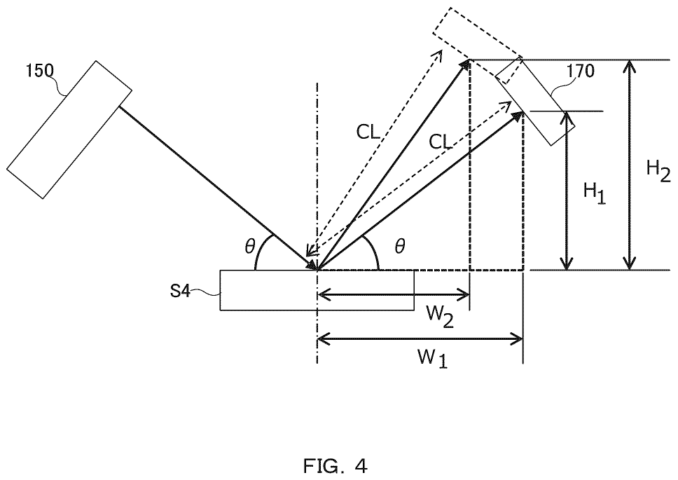

FIG. 4 is a schematic diagram showing an arrangement example of the incident optical system and the receiving optical system. In the X-ray measurement apparatus 100, the camera length CL and the diffraction angle 2θ can be arbitrarily set. The relation between the position (Hn, Wn) on a predetermined plane and the camera length CL and the diffracted angle 2θ is as follows.

Hn=sin θ×CL

Wn=cos θ×CL

Therefore, vertical movement, right-and-left movement and 2θ/θ movement by rotation of the detection section 170 on a predetermined plane are possible. For example, only for the detection section 170, vertical movement, right-and-left movement and rotation with fixing the camera length are performed, and the 2θ plurality exposure can be performed to the sample S4. If the angle of the χ axis, and the respective θ and the distance to the measured points of the irradiation section 150 and the detection section 170 are specified from the control apparatus 500, the arrangement is determined. In the X-ray measurement apparatus 100, the position of the irradiation section 150 is also freely movable on a predetermined plane.

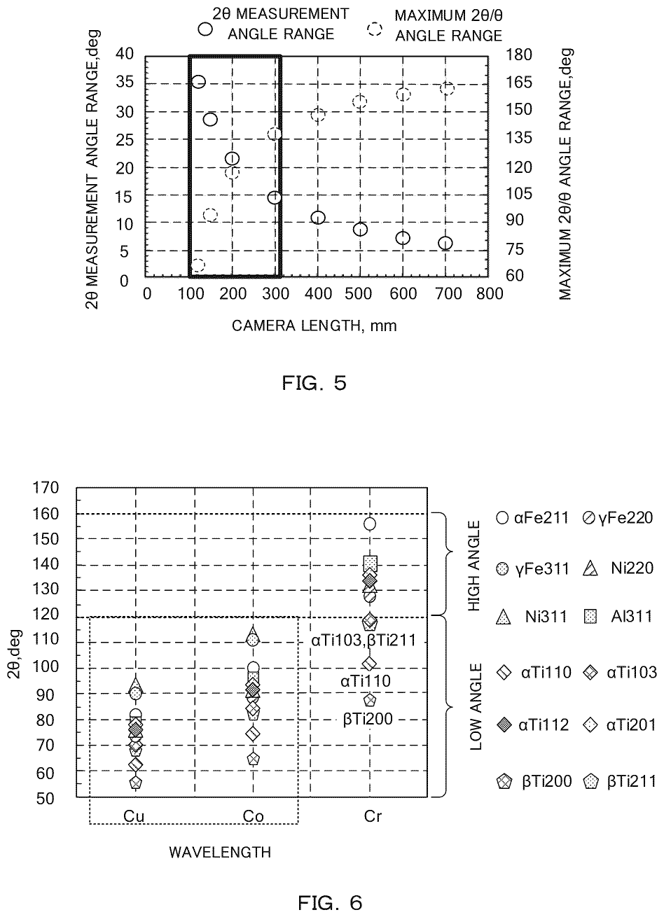

FIG. 5 is a graph showing a 2θ measurement angle range with respect to the camera length. With respect to the 2θ measurement angle range of 15° or more 35° or less and the maximum 2θ/θ angle of 60° or more 135° or less, the camera length of 100 mm or more 300 mm or less (in the area of the thick frame shown in FIG. 5) is often used in actual measurements. By using the X-ray measurement apparatus 100, it is possible to measure in this area.

FIG. 6 is a graph showing 2θ with respect to the wavelength of the characteristic X-rays of respective reflecting surfaces. For measurement of the high angle side with Cr wavelength, the evaluation is possible even in the conventional apparatus. On the other hand, when the sample is evaluated at an angle of 2 θ=135 degrees or less, the X-ray measurement apparatus 100 is suitable. Further, when the large complex shape portion is evaluated at a low angle of 2 θ=120° or less mainly with the wavelength of Cu or Co, the X-ray measurement apparatus 100 is more suitable.

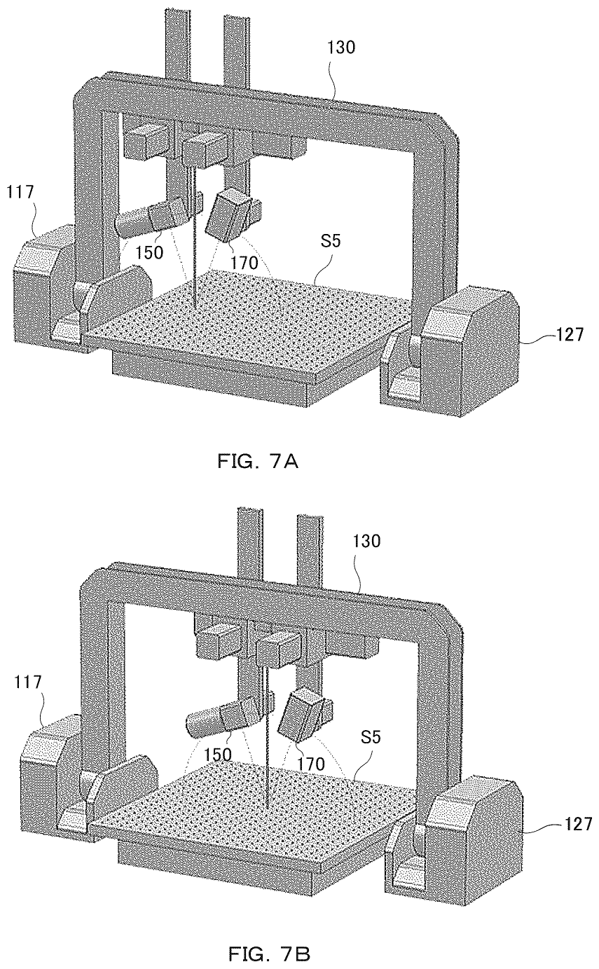

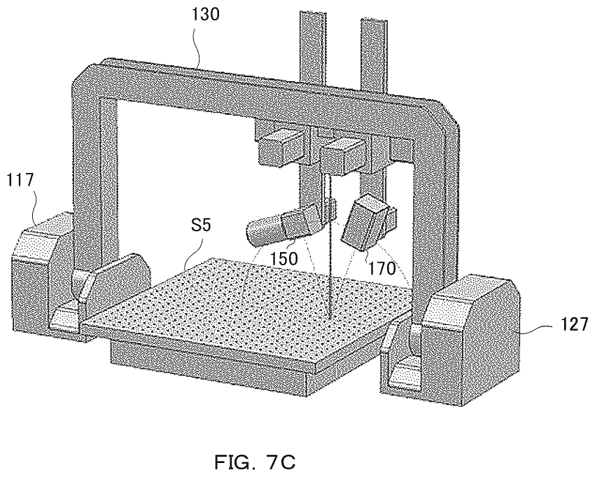

FIG. 7A to 7C are perspective views showing the X-ray measurement apparatus 100 when the measured position is set to the left side, the center and the right from front view along the incident surface, respectively. As shown in FIGS. 7A to 7C, the X-ray measurement apparatus 100 can easily perform measurement by moving the measured point on the sample S5.

(Arrangement at the Time of Sample Loading and Unloading)

If the irradiation section 150 and the detection section 170 are located near the center from front view of the X-ray measurement apparatus 100, the components and the movement axis may interfere, or come into contact with the sample and any of them may be damaged when the sample is loaded and unloaded. Therefore, in order to avoid such an accident, the irradiating section 150 and the detecting section 170 can be moved to the retraction position at the time of loading and unloading the sample.

For the retraction positions of the vertical movement axes of both θs side and θd side, the arrangement of the uppermost positions is exemplified, and for the retraction positions of the right-and-left movement axis, the arrangement of the end farthest position from the apparatus center (the position of the support portion side) is also exemplified. Thus, the respective axes and the parts to be mounted thereon will move to the position of the corner of the U-shaped frame 130, and it is possible to avoid an accident. Also, at the start and end of the measurement, they can be at the positions. Thus, the measurer can load and unload large or complex shaped samples and perform other necessary operations in a large space.

(Arrangement when Replacing Parts)

When the parts associated with the irradiation section 150 and the detection section 170 are replaced or maintained, the axes and parts can move in the vicinity of the center of the U-shaped frame 130. Thus, for example, during maintenance, the operator can easily work in a large space.

### Second Embodiment (Stress Analysis)

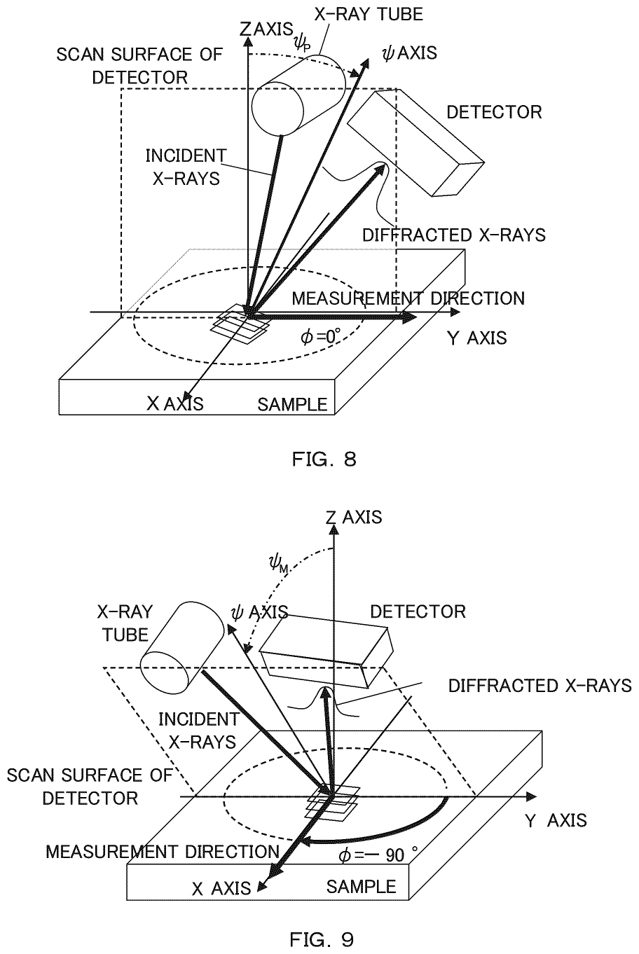

The X-ray measurement apparatus 100 is particularly suitable for stress analysis. FIG. 8 is a perspective view showing a configuration of the iso-inclination method. The iso-inclination method is a scanning method in which the detection section scanning plane (the plane formed by incident X-rays and diffracted X-rays) is parallel to the measurement direction. In the example shown in FIG. 8, the irradiation section 150 irradiates X-rays to the sample S6, the detection section 170 detects the X-rays diffracted by the sample S6, and the ψ axis is inclined toward the y-axis from the z-axis. In the arrangement as shown in FIGS. 7A to 7C, by adjusting the angles of the irradiation section 150 and the detecting section 170 to high angles, it is possible to easily perform the iso-inclination method using the X-ray measurement apparatus 100.

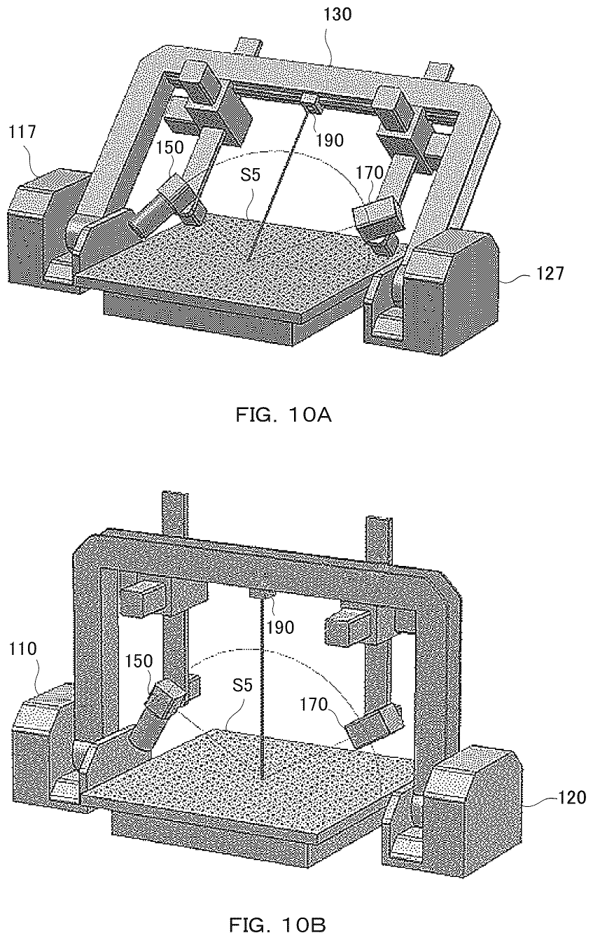

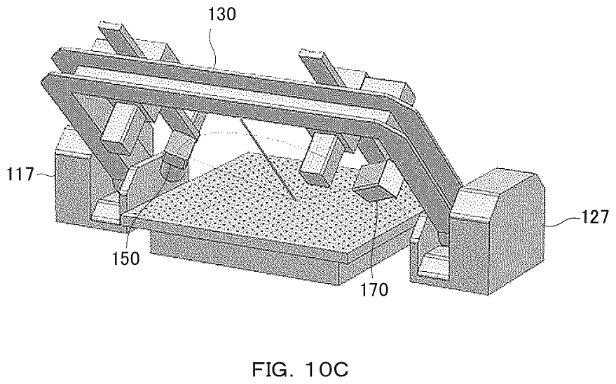

FIG. 9 is a perspective view showing a configuration of the side-inclination method. The side-inclination method is a scanning method in which the scanning plane of the detection section is perpendicular to the measurement direction. In the example shown in FIG. 9, the irradiation section 150 irradiates X-rays to the sample S6, the detection section 170 detects the X-rays diffracted by the sample S6, and ψ axis is inclined toward the χ-axis from the z-axis. The side-inclination method is effective for keeping the X-ray path when the tooth bottom of gear or the complicated shape part are measured. In the X-ray measurement apparatus 100, the side-inclination method can be easily performed by rotating the χ axis. FIGS. 10A to 10C are perspective views showing the X-ray measurement apparatus 100 set the inclination of respective frames on the rear side, the center and the front side, respectively. In this manner, the side-inclination method can be easily performed by appropriately arrangement on the plane and tilt of the incident plane (the predetermined plane) by the χ axis.

With the X-ray measurement apparatus 100, it is possible to use the diffraction beam of the low angle side without using the diffraction beam of the high angle side which is recommended in the stress measurement since the strain sensitivity is high (the peak shift amount is large). As a result, the interference between the sample and the apparatus is easily avoided, and the stress measurement of the complex shape portion becomes possible.

### Third Embodiment (Central Separation Type)

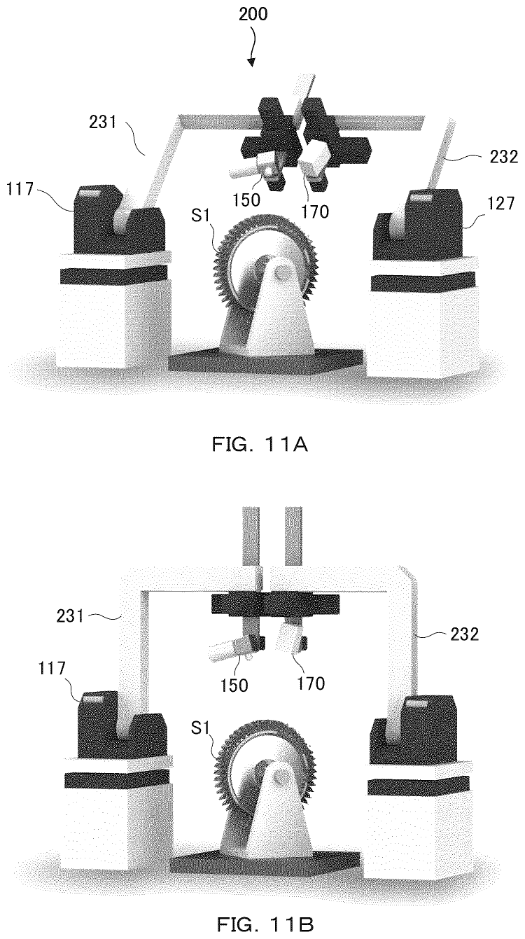

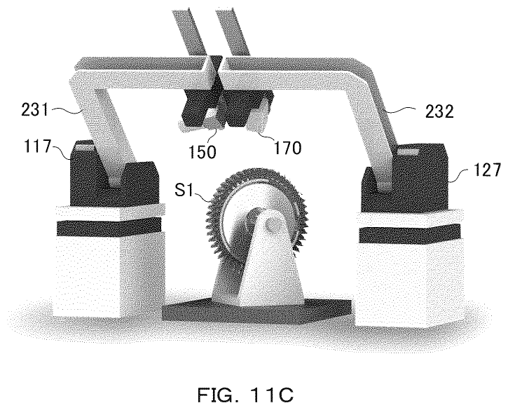

The frame 130 may be configured to be separated into sides of the irradiation section 150 and the detection section 170. Thus, the center of the separated frame 130 is empty, so that the measurement can be performed with the sample S having a large outer shape loaded therebetween. FIGS. 11A to 11C are perspective views showing high angle measurements by the X-ray measurement apparatus 200 which sets the inclination of the center separated frame to the rear side, the center and the front side, respectively. The X-ray measurement apparatus 200 is configured similarly to the X-ray measurement apparatus 100 except for the frame 231 and 232.

The frames 231 and 232 separated at the center are formed in an L-shape and are supported by the support sections 110 and 120, respectively. The χ-axis rotation angles of the frames 231 and 232 are configured to always coincide with each other. Therefore, even in this case, the irradiation section 150 and the detection section 170 move on the same plane. In the examples shown in FIG. 11A to 11C, the irradiation section 150 and the detection section 170 are located at the distal end of each L-shaped frame 231 and 232, are gathered in the central portion of the apparatus. In such a case, the diffraction angle is a high angle.

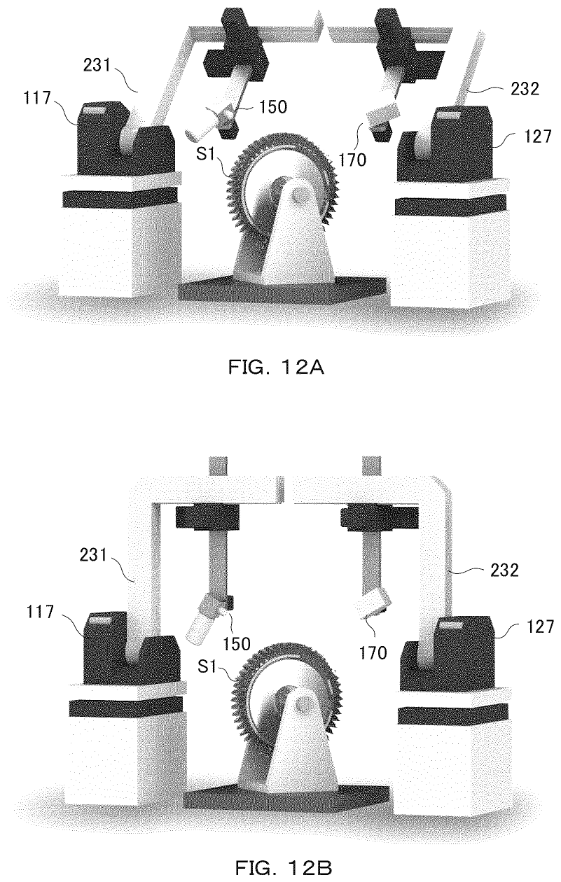

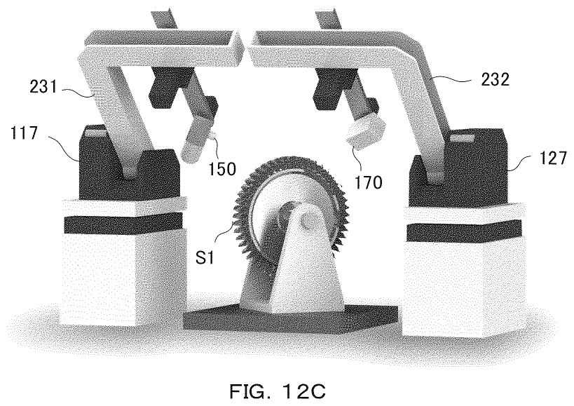

FIG. 12A to 12C are perspective views showing low angle measurements by the X-ray measurement apparatus 200 which sets the inclination of the center separated frame to the rear side, the center and the front side, respectively. In the example shown in FIG. 12A to 12C, the irradiation section 150 and the detection section 170 are located near the corners of the support sections 110 and 120, respectively. In such a case, the diffraction angle of the measured X-rays is a low angle. If the separation section of the frames 231 and 232 is made large, a large space can be kept between the frames 231 and 232. Then, even if the sample has a large-sized shape, it is easy to perform the measurement when the sample is loaded near the center of the apparatus.

### Fourth Embodiment (Counterweight Type)

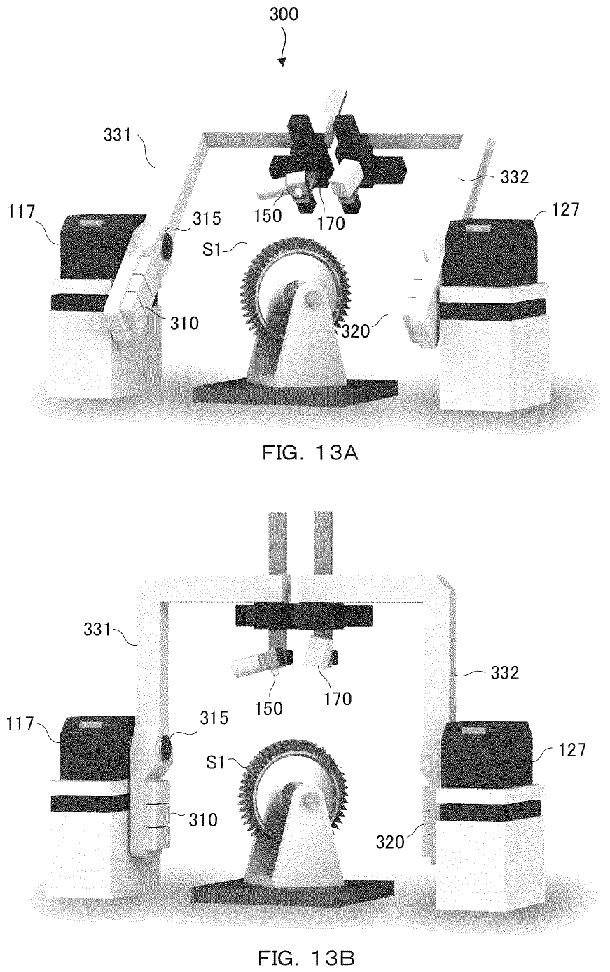

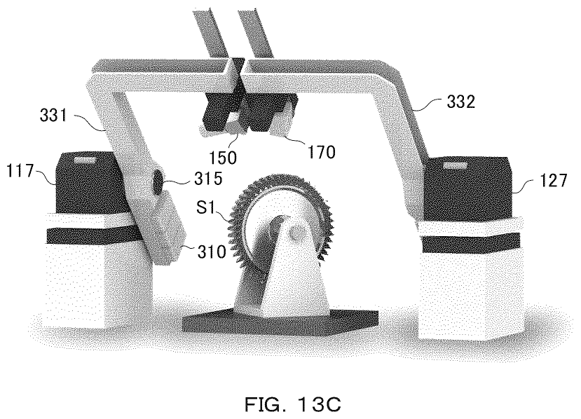

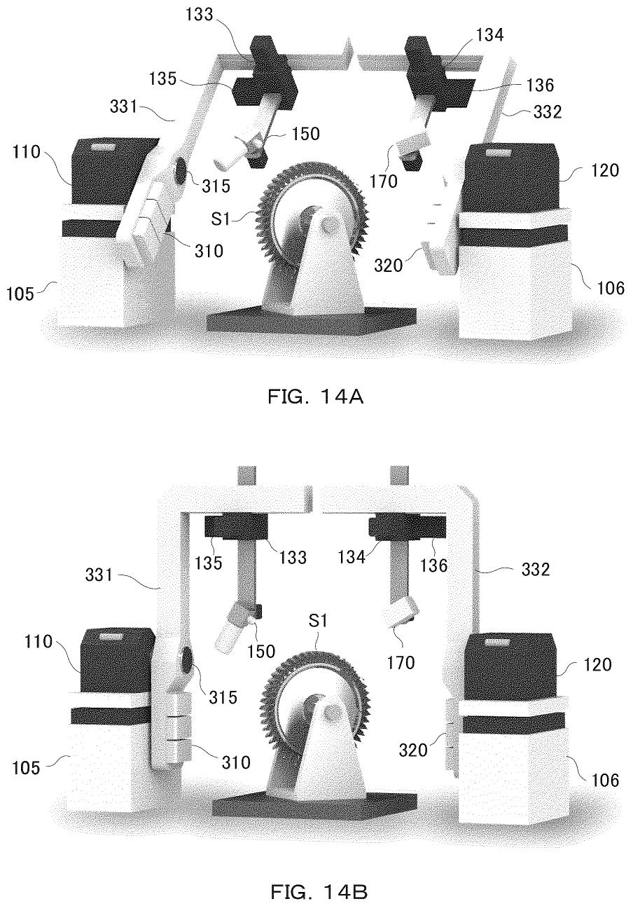

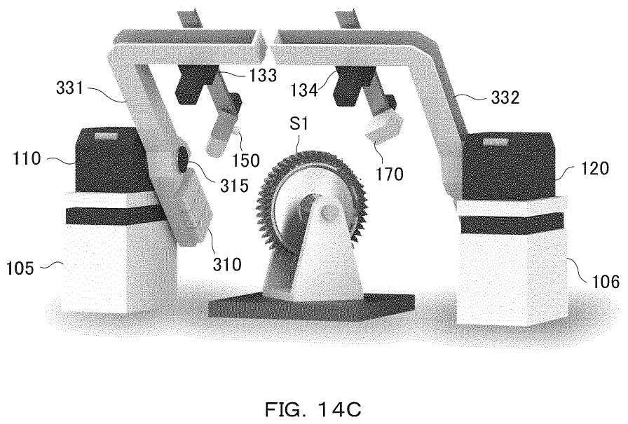

The configuration of the X-ray measurement apparatus 300 further having counterweights 310 and 320 is described in the fourth embodiment, although the X-ray measurement apparatus 200 having central separated frames is described In the third embodiment. FIGS. 13A to 13C are perspective views showing high angle measurements by the X-ray measurement apparatus 300 set the inclination of the center separated frame with counterweights the rear side, the center and the front side, respectively. FIGS. 14A to 14C are perspective views showing low angle measurements by the X-ray measurement apparatus 300 set the inclination of the center separated frame with counterweights on the rear side, the center and the front side, respectively.

The X-ray measurement apparatus 300 shown in 13C from FIG. 13A comprises counterweights 310 and 320 on the opposite sides of the fulcrum 315 of the frames 331 and 332. By placing the centroid position applied to the χ axis with counterweights 310 and 320 in the vicinity of the χ axis center, since the variation of the centroid position when the χ axis is inclined is reduced, each of the frames 331 and 332 can move smoothly at a small torque. In this way, the center of gravity position is fixed, χ-axis rotation of the frame 331 and 332 becomes smooth, it becomes controllable with high accuracy.

[Others]

Since the X-ray measurement apparatus 100 has a space where the tensile testing machine or fatigue testing machine or processing equipment or the like can be installed, the measurement can be performed in situ during the test. Not only the stress measurement but also the powder analysis can be carried out, and the analysis in the more advanced research and development can be carried out. Incidentally, the X-ray measurement apparatus 100 is applicable to not only a large sample or a sample of a complex shape but also small parts and parts of simple shapes.

Since there is a space in the direction in which each of frames 331 and 332 is inclined by χ axis rotation in the X-ray measurement apparatus 100, it is also possible to automatically flow the sample in one direction by a belt conveyor or the like in the space. By carrying in such a sample, it is possible to carry out the fully automatic sampling from the production line of the product and inspection. In that case, a sample can be also carried into the space, measured, and returned to the line if there is no problem.

1. A radiation measurement apparatus, comprising:
a pair of support sections arranged with a space for placing a sample,
a frame supported by the pair of support sections,
an irradiation section movably connected to the frame for irradiating radiation, and
a detection section movably connected to the frame for detecting radiation scattered by the sample,
wherein the irradiation section and the detection section are movable on a plane with respect to the frame.

2. The radiation measurement apparatus according to claim 1,
wherein the detection section has two parallel movement axes parallel to the plane and perpendicular to each other and one rotational movement axis perpendicular to the plane.

3. The radiation measurement apparatus according to claim 1,
wherein the irradiation section has two parallel movement axes parallel to the plane and perpendicular to each other and one rotational movement axis perpendicular to the plane.

4. The radiation measurement apparatus according to claim 1,
wherein the frame is supported by the pair of support sections at two fulcrums and has a rotational movement axis connecting the fulcrums.

5. The radiation measurement apparatus according to claim 1,
wherein the frame is formed as a single body.

6. The radiation measurement apparatus according to claim 1,
wherein the frame is configured to be separated into an irradiation section side and a detection section side.

7. The radiation measurement apparatus according to claim 1,
further comprising a sensor installed on the frame configured to detect the position of the sample surface.

8. The radiation measurement apparatus according to claim 1,
wherein the frame has a parallel movement mechanism capable of moving in a direction parallel to the plane with respect to the pair of support sections.

9. The radiation measurement apparatus according to claim 1,
wherein the pair of support sections has a movement mechanism capable of approaching and separating from a sample placed in the space.
